(19) United States
(12) Patent Application Publication
(10) Pub. No.: US 2010/0201924 A1
(43) Pub. Date: Aug. 12, 2010

(54) LIQUID CRYSTAL DISPLAY

(76) Inventors: Yi-Chun WU, Hua Lien City (TW); Yu-Cheng Liu, Taipei City (TW); Chun-chi Chi, Taichung County (TW)

Correspondence Address: Muncy, Geissler, Olds & Lowe, PLLC, 4000 Legato Road, Suite 310, FAIRFAX, VA, 22033, US

(21) Appl. No.: 12/704,057

(22) Filed: Feb. 11, 2010

(30) Foreign Application Priority Data
Feb. 12, 2009 (TW) 098104414

(51) Int. Cl. G02F 1/13363; G02F 1/1335

(52) U.S. Cl. 349/102; 349/96

(57) ABSTRACT

A normally-black mode liquid crystal display includes a first and a second transparent substrate facing to each other, a liquid crystal layer, a first and a second polarizer, a first and a second half wave plate, and a first and a second positive C plate. The liquid crystal layer is interposed between the first and the second transparent substrate. The first polarizer is disposed on a side of the first transparent substrate opposite the liquid crystal layer, while the second polarizer is disposed on a side of the second transparent substrate opposite the liquid crystal layer. The first half wave plate is provided between the first transparent substrate and the first polarizer, and the second half wave plate is provided between the second transparent substrate and the second polarizer. The first positive C plate is disposed between the first half wave plate and the first transparent substrate, and the second positive C plate is disposed between the second half wave plate and the second transparent substrate.

### CROSS REFERENCE TO RELATED APPLICATION

This application claims priority of application No. 098104414 filed in Taiwan R.O.C on Feb. 12, 2009 under 35 U.S.C. §119; the entire contents of which are hereby incorporated by reference.

### FIELD OF THE INVENTION

The invention relates to a normally-black mode liquid crystal display.

### DESCRIPTION OF THE RELATED ART

FIG. 1 shows a conventional normally-black mode transflective liquid crystal display 100. Referring to FIG. 1, the transflective liquid crystal display 100 comprises a dual-cell-gap liquid crystal (LC) cell 102, a first polarizer 104, a second polarizer 106, a first uniaxial half wave plate 108, and a second uniaxial half wave plate 110. The first polarizer 104 and the second polarizer 106 are respectively provided on two opposite sides of the dual-cell-gap LC cell 102, which has a transmissive region and a reflective region, and the transmissive region and the reflective region have different cell-gap thicknesses. The first uniaxial half wave plate 108 is interposed between the first polarizer 104 and the dual-cell-gap LC cell 102, while the second uniaxial half wave plate 110 is interposed between the second polarizer 106 and the dual-cell-gap LC cell 102, so that the liquid crystal display 100 is in a normally-black mode. Although such a conventional structure has advantages of thin thickness and low cost, there is still a lot of room for improving its viewing angle characteristic.

### BRIEF SUMMARY OF THE INVENTION

The invention provides a normally-black mode liquid crystal display that has excellent optoelectronic properties and wide viewing angle effect.

According to an embodiment of the invention, a normally-black mode liquid crystal display includes a first and a second transparent substrate facing to each other, a liquid crystal layer, a first and a second polarizer, a first and a second half wave plate, and a first positive C plate. The liquid crystal layer is interposed between the first and the second transparent substrate. The first polarizer is disposed on a side of the first transparent substrate opposite the liquid crystal layer, while the second polarizer is disposed on a side of the second transparent substrate opposite the liquid crystal layer. The first half wave plate is provided between the first transparent substrate and the first polarizer, the second half wave plate is provided between the second transparent substrate and the second polarizer, and the first positive C plate is disposed between the first half wave plate and the first transparent substrate.

According to another embodiment of the invention, a normally-black mode liquid crystal display includes a first and a second polarizer, a dual-cell-gap liquid crystal cell having a reflective region and a transmissive region, a first and a second half wave plate, and a first and a second positive C plate. The cell-gap thickness in the reflective region is different from the cell-gap thickness in the transmissive region. The first and the second polarizer are respectively provided on two opposite sides of the dual-cell-gap LC cell. The first half wave plate is provided between the first polarizer and the dual-cell-gap LC cell, and the second half wave plate is provided between the second polarizer and the dual-cell-gap LC cell. The first positive C plate is disposed between the first half wave plate and the dual-cell-gap LC cell, while the second positive C plate is disposed between the second half wave plate and the dual-cell-gap LC cell.

According to yet another embodiment of the invention, a normally-black mode liquid crystal display includes a first and a second transparent substrate facing to each other, a liquid crystal layer, a first and a second polarizer, and a first and a second half wave plate. The liquid crystal layer is interposed between the first and the second transparent substrate. The first polarizer is disposed on a side of the first transparent substrate opposite the liquid crystal layer, while the second polarizer is disposed on a side of the second transparent substrate opposite the liquid crystal layer. The first half wave plate is provided between the first transparent substrate and the first polarizer, and the second half wave plate is provided between the second transparent substrate and the second polarizer, wherein at least one of the first and the second half wave plate is a biaxial phase difference plate.

In one embodiment, the following equation is satisfied for the liquid crystal display:

2r2−2α+2r1−p1−p2=90°+N*180°

,where N is an integer, p1 is the transmission-axis azimuth of the first polarizer, r1 is the slow-axis azimuth of the first half wave plate, α is the oriented viewing angle of the liquid crystal display, p2 is the transmission-axis azimuth of the second polarizer, and r2 is the slow-axis azimuth of the second half wave plate.

In another embodiment, the thickness retardation value (Rₜₕ) of a positive C plate meets the following equation:

$${R}_{th} = ( \frac{{n}_{x} + {n}_{y}}{2} - {n}_{z} ) * d ,$$

where nₓ, n_{y}, and n_{z} are the refractive indices of the positive C plate in the X-axis, the Y-axis, and the thickness direction respectively, and d is the film thickness of the positive C plate.

In yet another embodiment, the biaxiality parameter (Nz) for the refractive index of a biaxial half wave plate can be defined by the following equation:

$$Nz = ( \frac{{n}_{x} - {n}_{z}}{{n}_{x} - {n}_{y}} ) ,$$

where nₓ, n_{y}, and n_{z} are the refractive indices of the biaxial half wave plate in the X-axis, the Y-axis, and the thickness direction respectively.

According to the above embodiments, the viewing angle characteristic can be enhanced simply by further providing one or two positive C plates or using a biaxial material to make a half wave plate in the conventional normally-black mode liquid crystal display.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 shows a schematic diagram illustrating a conventional normally-black mode transflective liquid crystal display.

FIG. 2 shows a schematic diagram illustrating optical characteristics of a dual-cell-gap LC cell.

FIG. 3 shows a schematic diagram illustrating a liquid crystal display according to an embodiment of the invention.

FIG. 4 shows a schematic diagram illustrating the configuration of a dual-cell-gap LC cell according to an embodiment of the invention.

FIG. 5 shows a curve diagram illustrating the V-R characteristics of the optical arrangement shown in FIG. 3, and FIG. 6 shows a curve diagram illustrating the V-T characteristics of the optical arrangement shown in FIG. 3.

FIGS. 7 and 8 show the viewing angle characteristics of the optical arrangement shown in FIG. 3.

FIG. 9 shows the viewing angle characteristics of an optical arrangement without the positive C plates in comparison with the optical arrangement shown in FIG. 3.

FIG. 10 shows a schematic diagram illustrating another embodiment of the invention.

FIG. 11 shows a schematic diagram illustrating another embodiment of the invention.

FIG. 12 shows a schematic diagram illustrating an LCD of another embodiment of the invention.

FIGS. 13 and 14 show the viewing angle characteristics of the optical arrangement shown in FIG. 12.

FIG. 15 shows a schematic diagram illustrating another embodiment of the invention.

FIG. 16 shows a schematic diagram illustrating another embodiment of the invention.

FIG. 17 shows a curve diagram illustrating the optimization of the phase retardation Δnd for an LC cell and a half wave plate.

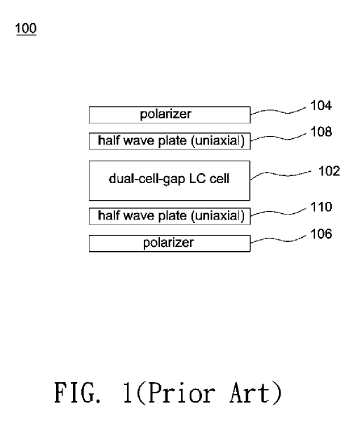

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and variations thereof herein are used broadly and encompass direct and indirect connections, couplings, and mountings. Similarly, “adjacent to” and variations thereof herein are used broadly and encompass directly and indirectly “adjacent to”. Therefore, the description of “A” component “adjacent to” “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

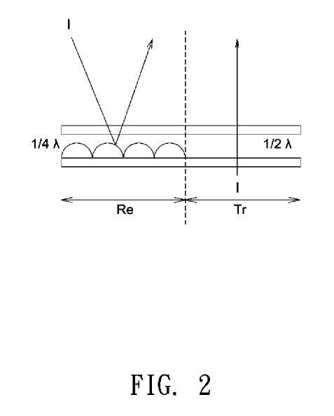

FIG. 2 shows a schematic diagram illustrating optical characteristics of a dual-cell-gap liquid crystal (LC) cell. In the design of a dual-cell-gap LC cell, the phase retardation Δnd of the LC layer for the transmissive region Tr satisfies the following equation:

$$Δ nd ( nm ) \geq 10 * \frac{560}{360} * ϕ ( ° )$$

$$Δ nd ( nm ) = 280 + N * 560 \pm 15 \% ,$$

where N is an integer, φ is the twist angle of LC molecules, and the incident light I that enters the dual-cell-gap LC cell is visible light (average wavelength of about 590 nm).

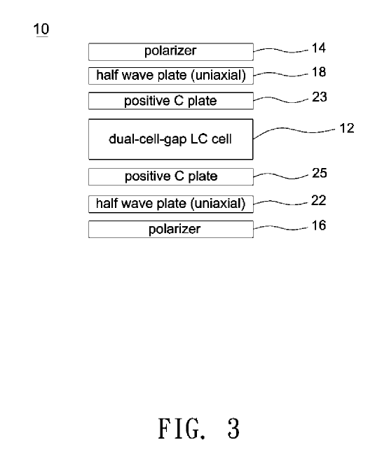

Since the ratio of the cell-gap thickness for the transmissive region Tr to that for the reflective region Re is about 2:1, the transmissive region Tr may be equated with a half wave plate, and the reflective region Re may be equated with a quarter wave plate. Hence, referring to FIG. 3, in a liquid crystal display (LCD) 10 according to an embodiment of the invention, a first polarizer 14 and a second polarizer 16 are respectively provided on two opposite sides of a dual-cell-gap LC cell 12. A first uniaxial half wave plate 18 is provided between the first polarizer 14 and the dual-cell-gap LC cell 12, and a second uniaxial half wave plate 22 is provided between the second polarizer 16 and the dual-cell-gap LC cell 12. A first positive C plate 23 is provided between the first uniaxial half wave plate 18 and the dual-cell-gap LC cell 12, while a second positive C plate 25 is provided between the second uniaxial half wave plate 22 and the dual-cell-gap LC cell 12.

In terms of in-plane refractivity of a positive C plate, assuming that the refractive indices in the X-axis, the Y-axis, and the thickness direction are nₓ, n_{y}, and n_{z} respectively, the relationship “nₓ=n_{y}<n_{z}” sustains for both of the first positive C plate 23 and the second positive C plate 25. Besides, in one embodiment, the thickness retardation value (Rₜₕ) of each of the first positive C plate 23 and the second positive C plate 25 meets the following equation:

$${R}_{th} = ( \frac{{n}_{x} + {n}_{y}}{2} - {n}_{z} ) * d ,$$

where d is the film thickness of the positive C plate.

Furthermore, if the incident light is visible light (average wavelength of about 590 nm), both the thickness retardation values (Rₜₕ) of the first positive C plate 23 and the second positive C plate 25 are preferably larger than −200 nm and less than −50 nm.

According to the optical arrangement of FIG. 3, the LCD 10 is in a normally black mode as the following equation is satisfied:

2r2−2α+2r1−p1−p2=90°+N*180°

, where N is an integer, p1 is the transmission-axis azimuth of the first polarizer 14, r1 is the slow-axis azimuth of the first uniaxial half wave plate 18, α is the oriented viewing angle of the LCD 10, p2 is the transmission-axis azimuth of the second polarizer 16, and r2 is the slow-axis azimuth of the second uniaxial half wave plate 22. The oriented viewing angle α is defined by the following description. In case a viewing direction is set as a 3 o'clock direction, the oriented viewing angle equals 0 degree as the twist angle is 0 degree, and the oriented viewing angle also equals 0 degree as the twist angle is 30 degrees, for there being symmetry between the viewing direction and the orientation of LC director as the twist angle is 30 degrees. Besides, in case the viewing direction is set as a 12 o'clock direction, the oriented viewing angle equals 90 degrees regardless of the value of the twist angle. Note the above equation is derived under an ideal achromatic condition for different wavelengths, and thus a tolerance of ±5 degrees for each angle solution of the above equation is permitted to form a normally black mode under a non-ideal situation, with the optimum angle solution being within the range of ±5 degrees for each angle solution.

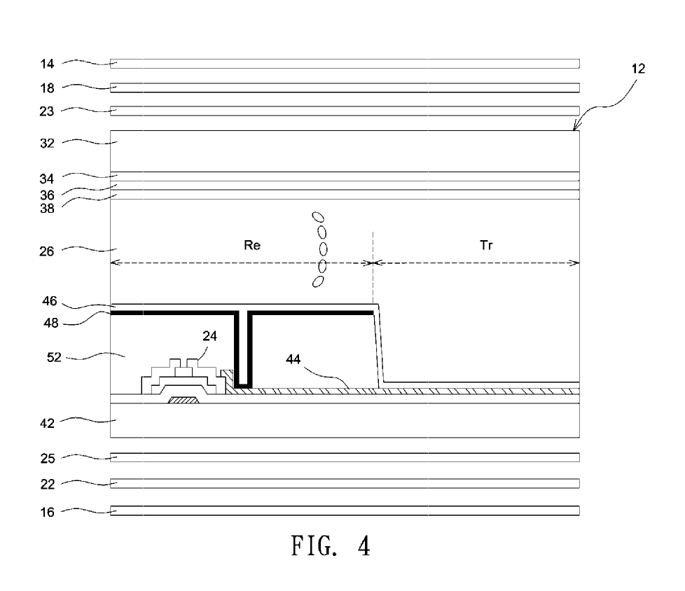

FIG. 4 shows a schematic diagram illustrating the configuration of a dual-cell-gap LC cell 12 according to an embodiment of the invention. Referring to FIG. 4, color filters 34, a common electrode 36 and a first alignment film 38 are formed on a first transparent substrate 32 in succession. Multiple transparent pixel electrodes 44 made from transparent conductive films, a second alignment film 46, and a switching device 24 such as a TFT are formed on a second transparent substrate 42. The first transparent substrate 32 and the second transparent substrate 42 face to each other, with a liquid crystal layer 26 interposed between them. The reflective pixel electrodes 48 are formed on a raised insulating layer 52 to enable the reflective region Re and the transmissive region Tr to have different cell-gap.

According to the above embodiment, by providing the positive C plates 23 and 25 between the dual-cell-gap LC cell 12 and the half wave plates 18 and 22 respectively, the normally-black mode LCD 10 can achieve an excellent viewing angle characteristic.

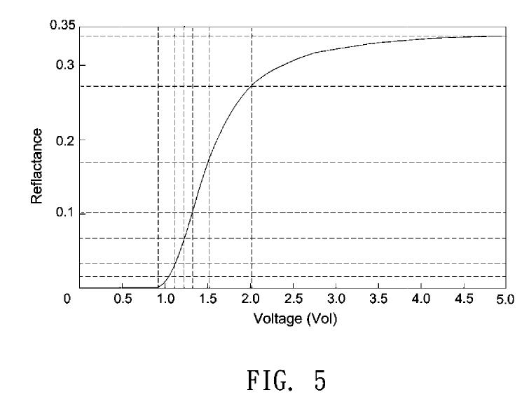

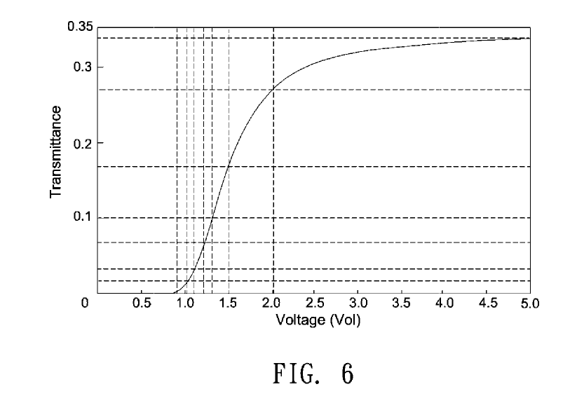

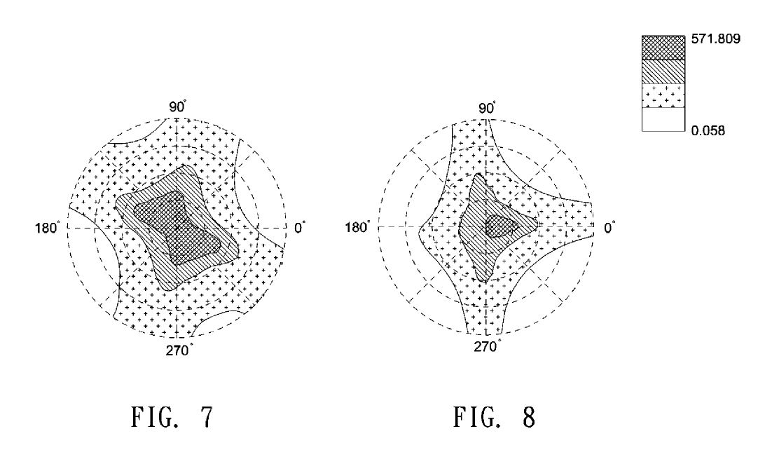

FIGS. 5 to 8 illustrate the optical characteristics of the arrangement shown in FIG. 3, wherein FIG. 5 shows a curve diagram illustrating the V-R characteristics (voltage versus light reflectance), FIG. 6 shows a curve diagram illustrating the V-T characteristics (voltage versus light transmittance), FIG. 7 shows the viewing angle characteristics for the reflective region Re, and FIG. 8 shows the viewing angle characteristics for the transmissive region Tr. The results are simulated under the conditions that the transmission-axis azimuth p1 equals 75 degrees, the transmission-axis azimuth p2 equals 5 degrees, the slow-axis azimuth r1 equals 60 degrees, the slow-axis azimuth r2 equals 115 degrees, the oriented viewing angle α equals 0 degree, and the thickness retardation value of the positive C plate equals −100 nm.

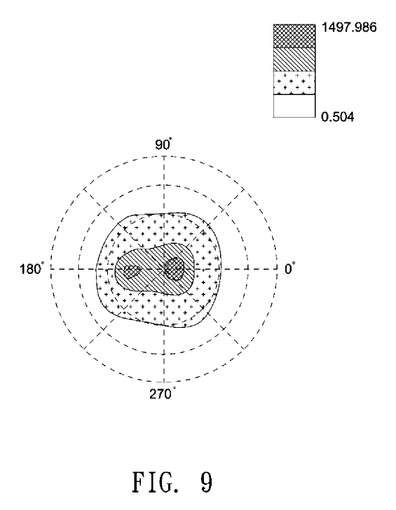

As shown in FIGS. 5 and 6, the optical arrangement shown in FIG. 3 achieves optimum optical matching in both the transmissive region Tr and the reflective region Re, and a fully black display under a normally black mode is obtained in both the transmissive region Tr and the reflective region Re when no voltage is applied. Besides, FIG. 9 shows the viewing angle characteristics for the transmissive region of a similar optical arrangement without the positive C plates 23 and 25, which were obtained under the same simulation conditions. Compared with the viewing angle characteristics shown in FIG. 9, this embodiment with the configuration shown in FIG. 3 can achieve a viewing angle larger than 80 degrees in 3, 6, and 12 o'clock direction under a condition that the contrast ratio is 10 (the outermost circle of the concentric circles), and achieve a viewing angle of about 50 degrees in 9 o'clock direction, as shown in FIG. 8. However, the optical arrangement without a positive C plate merely achieves an average viewing angle of about 40 degrees under a condition that the contrast ratio is 10, as shown in FIG. 9, and it even achieves a best viewing angle of only about 50 degrees in 9 o'clock direction. Thus, according to the design of this embodiment with the positive C plates, the viewing angle of a normally-black mode liquid crystal display can be significantly enhanced.

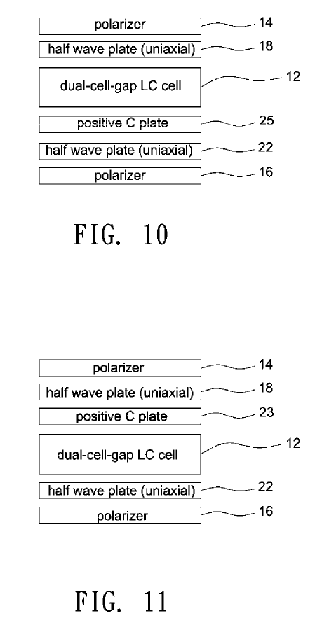

Moreover, in another embodiment, the viewing angle can also be increased by using only one positive C plate. For example, only the positive C plate 25 is disposed under the dual-cell-gap LC cell 12 (FIG. 10), or only the positive C plate 23 is disposed above the dual-cell-gap LC cell 12 (FIG. 11).

In addition to interposing a positive C plate between the half wave plate and the dual-cell-gap LC cell, a wide viewing angle can also be accomplished by altering the material of the half wave plate. Referring to FIG. 12, in a liquid crystal display (LCD) 10 according to an embodiment of the invention, a first polarizer 14 and a second polarizer 16 are respectively provided on two opposite sides of a dual-cell-gap LC cell 12. A first biaxial half wave plate 18′ is provided between the first polarizer 14 and the dual-cell-gap LC cell 12, and a second biaxial half wave plate 22′ is provided between the second polarizer 16 and the dual-cell-gap LC cell 12.

Assuming that the refractive indices of a half wave plate in the X-axis, the Y-axis, and the thickness direction are nₓ, n_{y}, and n_{z} respectively, the relationship “nₓ>n_{y} and n_{z}>n_{y}” sustains for both of the first and the second biaxial half wave plate. Since the biaxial material has a larger value of n_{z}, a compensation effect will be caused in the Z-axis direction so as to enhance the viewing angle in this embodiment. Besides, in one embodiment, the biaxiality parameter (Nz) for the refractive index of each of the first and the second biaxial half wave plate can be defined by the following equation:

$$Nz = ( \frac{{n}_{x} - {n}_{z}}{{n}_{x} - {n}_{y}} )$$

Furthermore, if the incident light is visible light (average wavelength of about 590 nm), the biaxiality parameter (Nz) for the refractive index of each of the first and the second biaxial half wave plate is preferably larger than −1 and less than 1.

According to the optical arrangement of FIG. 12, the LCD is in a normally black mode as the following equation is satisfied:

2r2−2α+2r1−p1−p2=90°+N*180°

, where N is an integer, p1 is the transmission-axis azimuth of the first polarizer 14, r1 is the slow-axis azimuth of the first biaxial half wave plate 18′, α is the oriented viewing angle of the LCD 10, p2 is the transmission-axis azimuth of the second polarizer 16, and r2 is the slow-axis azimuth of the second biaxial half wave plate 22′. Note the above equation is derived under an ideal achromatic condition for different wavelengths, and thus a tolerance of ±5 degrees for each angle solution of the above equation is permitted to form a normally black mode under a non-ideal situation, with the optimum angle solution being within the range of ±5 degrees for each angle solution.

According to the above embodiment, by changing the material of the half wave plate from uniaxial material to biaxial material, the normally-black mode LCD 10 can achieve an excellent viewing angle characteristic.

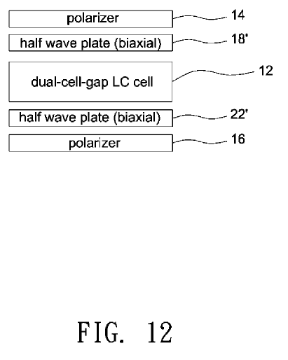

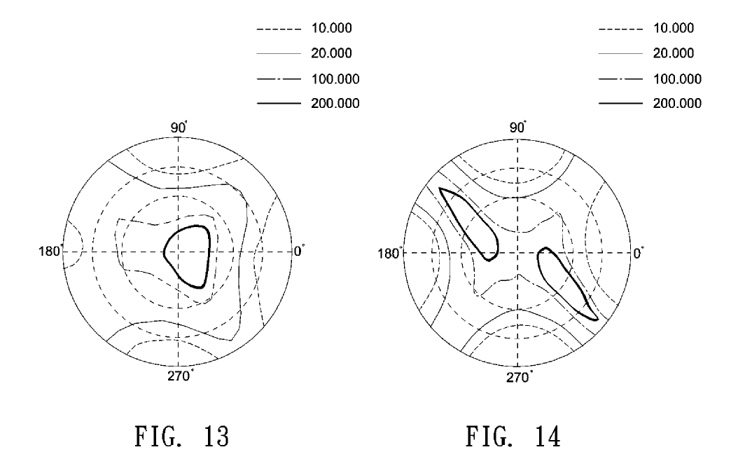

FIGS. 13 and 14 show the viewing angle characteristics of the transmissive region and the reflective region, respectively, according to the arrangement shown in FIG. 12. The results are simulated under the conditions that the transmission-axis azimuth p1 equals 75 degrees, the transmission-axis azimuth p2 equals 5 degrees, the slow-axis azimuth r1 equals 60 degrees, the slow-axis azimuth r2 equals 115 degrees, the oriented viewing angle α equals 0 degree, and the biaxiality parameter Nz for the refractive index of each of the first and the second biaxial half wave plate equals 0.2727. Comparing the viewing angle characteristics shown in FIG. 13 with those shown in FIG. 9, this embodiment with the configuration shown in FIG. 12 can achieve a viewing angle larger than 80 degrees in 1.5, 4.5, 7.5, and 10.5 o'clock direction under a condition that the contrast ratio is 10 (the outermost circle of the concentric circles), and achieve a viewing angle of about 50 degrees even in the worst situation. However, the optical arrangement using a uniaxial half wave plate merely achieves an average viewing angle of about 40 degrees under a condition that the contrast ratio is 10, as shown in FIG. 9, and it even achieves a best viewing angle of only about 50 degrees in 9 o'clock direction. Thus, by altering the material of the half wave plate in this embodiment, the viewing angle of a normally-black mode liquid crystal display can be significantly enhanced.

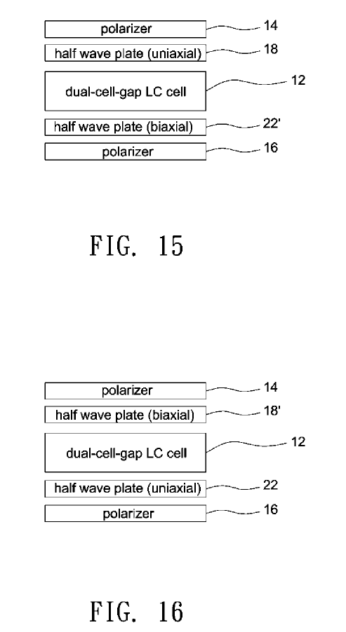

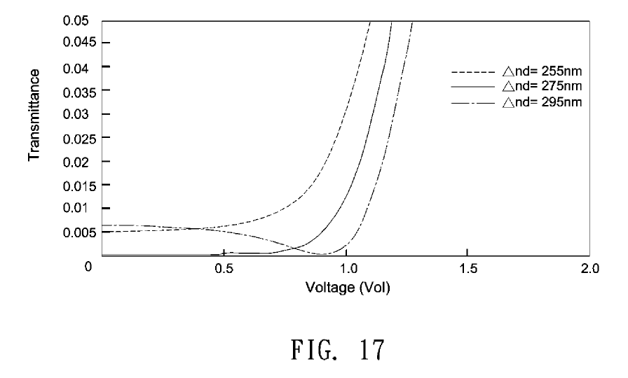

Moreover, in another embodiment, the viewing angle can also be increased by varying the material of only one half wave plate. For example, only the half wave plate 22′ below the dual-cell-gap LC cell 12 is a biaxial half wave plate (FIG. 15), or only the half wave plate 18′ above the dual-cell-gap LC cell 12 is a biaxial half wave plate (FIG. 16).

FIG. 17 shows a curve diagram illustrating the optimization of the phase retardation Δnd for an LC cell and a half wave plate. Particularly, FIG. 17 shows three V-T curves respectively representing the LC-cell phase retardations Δnd_{CELL} of 255 nm, 275 nm, and 295 nm, under the condition where a half wave plate having a phase retardation Δnd_{WP} of 275 nm is used. Referring to FIG. 17, in case the LC-cell phase retardations Δnd_{CELL} (such as 255 nm) is lower than the half wave-plate phase retardation Δnd_{WP} (such as 275 nm), a fully-black section where the light transmittance is extremely low could not be found in the V-T curve, and thus the display contrast is inferior. Hence, in one embodiment, the LC-cell phase retardation Δnd_{CELL} for the trnamissive region is set as larger than the half wave-plate phase retardation Δnd_{WP}, and a prefer range of their difference value is 0-30 nm (30 nm>Δnd_{CELL}−Δnd_{WP}>0 nm) to obtain liable optical characteristics.

For example, the LC-cell phase retardation Δnd_{CELL} may be larger than the half wave-plate phase retardation Δnd_{WP} by about 20 nm, with the process tolerance being taken into consideration. Besides, a prefer range of phase retardation Δnd_{WP} of the half wave plate is set as larger than 200 nm and smaller than 360 nm.

Further, though the above embodiments are exemplified by a dual-cell-gap LC cell, this is not limited. Other type such as a transmissive LCD may also be used in the above embodiments to form a normally black mode having superior viewing angle characteristics.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A liquid crystal display with a normally-black mode comprising:
a first and a second transparent substrate facing to each other;
a liquid crystal layer interposed between the first and the second transparent substrate;
a first polarizer disposed on a side of the first transparent substrate opposite the liquid crystal layer;
a second polarizer disposed on a side of the second transparent substrate opposite the liquid crystal layer;
a first half wave plate provided between the first transparent substrate and the first polarizer;
a second half wave plate provided between the second transparent substrate and the second polarizer; and
a first positive C plate disposed between the first half wave plate and the first transparent substrate.

2. The liquid crystal display as claimed in claim 1, wherein the following equation is satisfied for the liquid crystal display:
2r2−2α+2r1−p1−p2=90°+N*180°
, where N is an integer, p1 is the transmission-axis azimuth of the first polarizer, r1 is the slow-axis azimuth of the first half wave plate, α is the oriented viewing angle of the liquid crystal display, p2 is the transmission-axis azimuth of the second polarizer, r2 is the slow-axis azimuth of the second half wave plate, and a tolerance of ±5 degrees for each angle solution of the equation is permitted to form the normally black mode.

3. The liquid crystal display as claimed in claim 1, wherein the thickness retardation value (Rₜₕ) of the first positive C plate meets the following equation:
$${R}_{th} = ( \frac{{n}_{x} + {n}_{y}}{2} - {n}_{z} ) * d ,$$
where nₓ, n_{y}, and n_{z} are the refractive indices of the first positive C plate in the X-axis, the Y-axis, and the thickness direction respectively, and d is the film thickness of the first positive C plate.

4. The liquid crystal display as claimed in claim 3, wherein the phase retardations of the first half wave plate and the second half wave plate are both larger than 200 nm and smaller than 360 nm, and the thickness retardation value of the first positive C plate is larger than −200 nm and smaller than −50 nm.

5. The liquid crystal display as claimed in claim 1, further comprising a second positive C plate disposed between the second half wave plate and the second transparent substrate, and the following equation is satisfied for the liquid crystal display:
2r2−2α+2r1−p1−p2=90°+N*180°
, where N is an integer, p1 is the transmission-axis azimuth of the first polarizer, r1 is the slow-axis azimuth of the first half wave plate, α is the oriented viewing angle of the liquid crystal display, p2 is the transmission-axis azimuth of the second polarizer, r2 is the slow-axis azimuth of the second half wave plate, and a tolerance of ±5 degrees for each angle solution of the equation is permitted to form the normally black mode.

6. The liquid crystal display as claimed in claim 5, wherein the thickness retardation value (Rₜₕ) of each of the first positive C plate and the second positive C plate meets the following equation:
$${R}_{th} = ( \frac{{n}_{x} + {n}_{y}}{2} - {n}_{z} ) * d ,$$
where nₓ, n_{y}, and n_{z} are the refractive indices of the positive C plate in the X-axis, the Y-axis, and the thickness direction respectively, and d is the film thickness of the positive C plate, the thickness retardation values of the first positive C plate and the second positive C plate are both larger than −200 nm and smaller than −50 nm, and the phase retardations of the first half wave plate and the second half wave plate are both larger than 200 nm and smaller than 360 nm.

7. A liquid crystal display with a normally-black mode comprising:
a dual-cell-gap liquid crystal (LC) cell having a reflective region and a transmissive region, and the cell-gap thickness in the reflective region being different from the cell-gap thickness in the transmissive region;
a first and a second polarizer respectively provided on two opposite sides of the dual-cell-gap LC cell;
a first half wave plate provided between the first polarizer and the dual-cell-gap LC cell;
a second half wave plate provided between the second polarizer and the dual-cell-gap LC cell; and
a first positive C plate disposed between the first half wave plate and the dual-cell-gap LC cell.

8. The liquid crystal display as claimed in claim 7, wherein the phase retardation for the transmissive region satisfies the following equation:
$$Δ nd ( nm ) \geq 10 * \frac{560}{360} * ϕ ( ° )$$
$$Δ nd ( nm ) = 280 + N * 560 \pm 15 \% ,$$
where N is an integer, φ is the twist angle of LC molecules, and the incident light that enters the dual-cell-gap LC cell is visible light.

9. The liquid crystal display as claimed in claim 7, wherein the normally black mode is obtained when the following equation is satisfied:
2r2−2α+2r1−p1−p2=90°+N*180°
, where N is an integer, p1 is the transmission-axis azimuth of the first polarizer, r1 is the slow-axis azimuth of the first half wave plate, α is the oriented viewing angle of the liquid crystal display, p2 is the transmission-axis azimuth of the second polarizer, r2 is the slow-axis azimuth of the second half wave plate, and a tolerance of ±5 degrees for each angle solution of the equation is permitted to form the normally black mode.

10. The liquid crystal display as claimed in claim 7, wherein the thickness retardation value (Rₜₕ) of the first positive C plate meets the following equation:
$${R}_{th} = ( \frac{{n}_{x} + {n}_{y}}{2} - {n}_{z} ) * d ,$$
where nₓ, n_{y}, and n_{z} are the refractive indices of the first positive C plate in the X-axis, the Y-axis, and the thickness direction respectively, and d is the film thickness of the first positive C plate.

11. The liquid crystal display as claimed in claim 10, wherein the phase retardations of the first half wave plate and the second half wave plate are both larger than 200 nm and smaller than 360 nm, and the thickness retardation value of the first positive C plate is larger than −200 nm and smaller than −50 nm.

12. The liquid crystal display as claimed in claim 7, further comprising a second positive C plate disposed between the second half wave plate and the dual-cell-gap LC cell, the thickness retardation value (Rₜₕ) of each of the first positive C plate and the second positive C plate meets the following equation:
$${R}_{th} = ( \frac{{n}_{x} + {n}_{y}}{2} - {n}_{z} ) * d ,$$
where nₓ, n_{y}, and n_{z} are the refractive indices of the positive C plate in the X-axis, the Y-axis, and the thickness direction respectively, and d is the film thickness of the positive C plate.

13. The liquid crystal display as claimed in claim 12, wherein the phase retardations of the first half wave plate and the second half wave plate are both larger than 200 nm and smaller than 360 nm, and the thickness retardation values of the first positive C plate and the second positive C plate are both larger than −200 nm and smaller than −50 nm.

14. The liquid crystal display as claimed in claim 12, wherein the phase retardation for the transmissive region of the dual-cell-gap LC cell is larger than the phase retardations of the first half wave plate and the second half wave plate, the difference value between the phase retardation for the transmissive region of the dual-cell-gap LC cell and the phase retardation of the first half wave plate is smaller than 30 nm, and the difference value between the phase retardation for the transmissive region of the dual-cell-gap LC cell and the phase retardation of the second half wave plate is smaller than 30 nm.

15. A liquid crystal display with a normally-black mode comprising:
a first and a second transparent substrate facing to each other;
a liquid crystal layer interposed between the first and the second transparent substrate;
a first polarizer disposed on a side of the first transparent substrate opposite the liquid crystal layer;
a second polarizer disposed on a side of the second transparent substrate opposite the liquid crystal layer;
a first half wave plate provided between the first transparent substrate and the first polarizer; and
a second half wave plate provided between the second transparent substrate and the second polarizer;
wherein at least one of the first and the second half wave plate is a biaxial half wave plate.

16. The liquid crystal display as claimed in claim 15, wherein the following equation is satisfied for the liquid crystal display:
2r2−2α+2r1−p1−p2=90°+N*180°
, where N is an integer, p1 is the transmission-axis azimuth of the first polarizer, r1 is the slow-axis azimuth of the first half wave plate, α is the oriented viewing angle of the liquid crystal display, p2 is the transmission-axis azimuth of the second polarizer, r2 is the slow-axis azimuth of the second half wave plate, and a tolerance of ±5 degrees for each angle solution of the equation is permitted to form the normally black mode.

17. The liquid crystal display as claimed in claim 15, wherein both the phase retardations of the first half wave plate and the second half wave plate are larger than 200 nm and smaller than 360 nm.

18. The liquid crystal display as claimed in claim 15, wherein the biaxiality parameter for the refractive index of each of the first and the second half wave plate is defined by the following equation:
$$Nz = ( \frac{{n}_{x} - {n}_{z}}{{n}_{x} - {n}_{y}} ) ,$$
where Nz is the biaxiality parameter and nₓ, n_{y}, and n_{z} are the refractive indices of the half wave plate in the X-axis, the Y-axis, and the thickness direction respectively.

19. The liquid crystal display as claimed in claim 18, wherein both the biaxiality parameters for the refractive index of the first half wave plate and the second half wave plate are larger than −1 and less than 1.
